(19) United States
(12) Patent Application Publication
(10) Pub. No.: US 2013/0132174 A1
(43) Pub. Date: May 23, 2013

(54) SYSTEM FOR ATTRACTING CUSTOMERS

(71) Applicant: Reza Faraee, Moreno Valley, CA (US)

(72) Inventor: Reza Faraee, Moreno Valley, CA (US)

(21) Appl. No.: 13/744,738

(22) Filed: Jan. 18, 2013

Related U.S. Application Data
(63) Continuation of application No. 12/120,042, filed on May 13, 2008, now abandoned.

(51) Int. Cl. G06Q 30/02

(52) U.S. Cl. CPC G06Q 30/0214
USPC 705/14.16

(57) ABSTRACT

A system for attracting new customer comprises providing a coupon to an existing customer, the coupon identifying only the customer and when that coupon is redeemed by a second customer, the first customer receives value.

### BACKGROUND

The present application is a Continuation of U.S. patent application Ser. No. 12/120,042, titled “System for Attracting Customers” and filed on May 13, 2008, the contents of which are incorporated in this disclosure by reference in their entirety.

There are many systems for attracting customers. Among the systems are multi-level marketing (MLM) and coupons. MLM systems allow an individual to sign up as a direct distributor of products for a company and earn compensation by means of relationship referral and direct selling. The distributor receives a commission relative to the volume of product sold by themselves and through each of the one or more referrals that also sign up as a distributor of the company's products. Distributors earn a commission based on the sales of the hierarchical organization that includes the sales efforts of the distributor and the leveraged sales efforts of the distributor's hierarchy. Commissions are paid to each MLM distributor according to the company's compensation plan. There can be multiple levels of people receiving royalties from one person's sales. Disadvantageously, each distributor must recruit and retain their own sales force. Further, the calculations required to total the commissions for each distributor is complex and cumbersome.

Coupons are another form of attracting customers. Coupons were invented in 1894 by Asa Candler, who gave out handwritten tickets for a free glass of his new fountain drink, Coca-Cola. The idea moved into grocery stores the next year. Coupons have remained a staple of commerce since their inception and continue to grow in popularity, for example, in 2002 shoppers saved $3 billion dollars by redeeming 3.8 billion coupons. Disadvantageously, coupons must be sent out to each and every consumer costing hundreds of thousands of dollars. Further, the over abundance of coupons makes it difficult for the average consumer to use more than a few coupons while shopping and usually only if the coupon is for an item of particular interest to the consumer.

MLM systems are difficult to set up and establish. Coupons enjoy greater acceptance, but do not provide the advantages of the MLM system.

Therefore there is a need for a system for marketing and attracting customers without the disadvantages of MLM and coupon systems.

Information about MLM systems and coupons can be found in U.S. Pat. Nos. 5,537,314, 6,334,111, 6,405,175, 7,225,267, and 6,029,141; and United States Patent Publications: 2004/0254831, 2005/0080670, 2005/0171838, 2005/0267809, 2005/0267810, 2006/0041478, 2006/0195360, 2006/0229936, 2006/0247969, 2007/0185766, 2007/0265921, 2007/0288312, 2008/0052167, 2008/0052169, and 2004/0093269.

### SUMMARY

[To be completed after claims have been approved]

### DRAWINGS

These and other features, aspects and advantages of the present invention will become better understood with regard to the following description, appended claims, and accompanying figures where:

FIG. 1 is a flow chart diagram of some of the steps of a first customer attracting system according to one version of the present invention;

FIG. 2 is a flow chart diagram of some steps for calculating compensation in the system of FIG. 1;

FIG. 3 is a flow chart diagram of some steps for processing account credits for an existing entity's account based on a purchase by a referring entity of FIG. 1;

FIG. 4 is a flow chart diagram of some steps for providing a coupon to an entity of FIG. 1;

FIG. 5 is a flow chart diagram of some steps for providing a coupon to an entity according to another version of the present invention; and

FIG. 6 is a flow chart diagram of some of the steps of a second customer attracting system according to another version of the present invention.

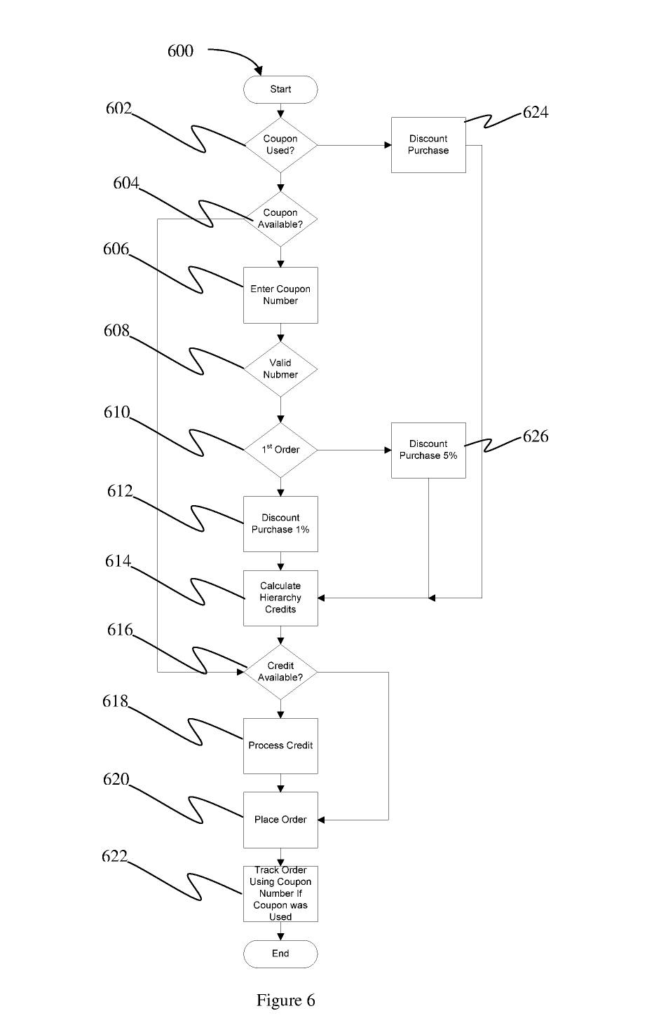

### DESCRIPTION

The present invention overcomes limitations of both coupons and MLM systems. The system described herein uses the wide acceptance of coupons, that can be passed from entity to entity, and provides the attendant advantages of an MLM system without the need to recruit new referrals face to face. Using an electronic coupon, the costs associated with distribution of coupons is greatly reduced and the potential market for coupon incentivized use is greatly expanded.

The term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise.

The term entity refers to anything that has a distinct, separate existence, though it need not be a material existence and capable of bearing legal rights and obligations, such as a business entity or a corporate entity, an artificial person, a natural person, a partnership, and an unincorporated association.

The term identifier refers to an object, a token a string of characters, sequence of bits or other data that establishes the identity or a connection to a particular person or thing. For example, a social security number, an email address, a bar code, a drivers license number, among others.

The term coupon refers to a ticket or document, either printed or electronic, that can be exchanged for value, such as, for example, a paper coupon, an e-mail message, a bar code, or a uniform resource locator (URL) link on a web page.

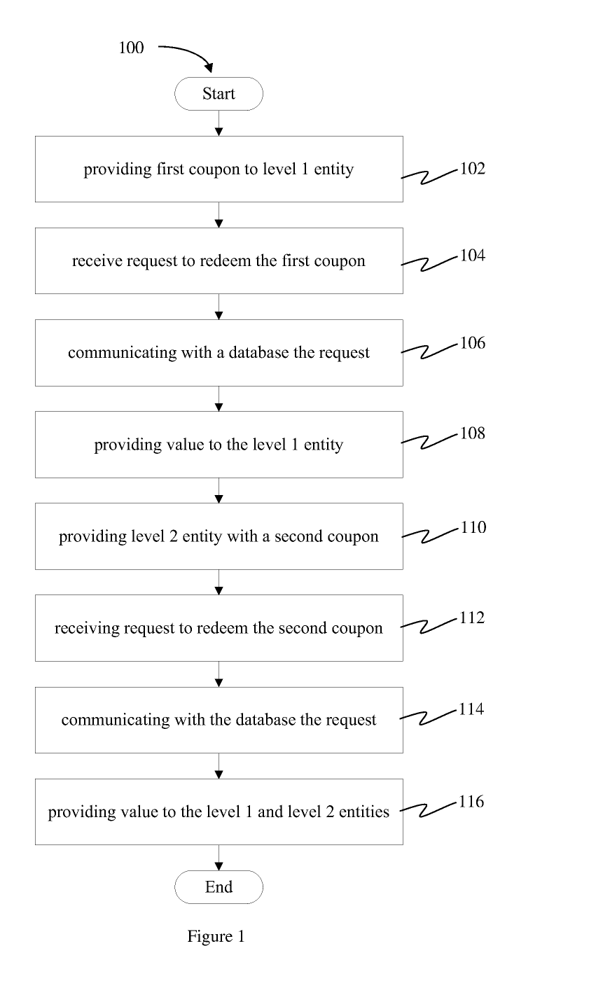

Referring now to FIG. 1, the system includes a method and a computer system for implementing the method. According to one version, the method comprises providing a first coupon 102 to a level lentity, the first coupon having an identifier associated only with the level 1 entity. Typically, the level 1 entity provides the first coupon 102 to a level 2 entity. Next, a request is received 104 to redeem the first coupon from the level 2 entity, wherein the request identifies the identifier of the first coupon. Then, the request from the level 2 entity is communicated 106 to a database and the level 2 entity is associated with the level 1 entity. The association is a link between the level 1 and the level 2 entities that allows the company to trace how the level 2 entity became a customer. Next, a value is provided 108 to the level 1 entity for at least one purchase by the level 2 entity, thereby rewarding the level 1 entity for recruiting the level 2 entity. Then, the level 2 entity is provided 110 with a second coupon having an identifier associated only with the level 2 entity. Next, a request is received 112 to redeem the second coupon from a level 3 entity, wherein the request identifies the identifier of the second coupon. Then, the request from the level 3 entity is communicated 114 to the database for associating the level 2 entity and the level 3 entity in a hierarchal manner when it is received. The term hierarchal refers to an arrangement of objects, entities, people, elements, values, grades, orders, classes, etc., in a linked series vertically downwards via a single or multiple links in the same direction. Next, a value is provided 116 to the level land level 2 entities for at least one purchase by the level 3 entity.

For example, entities that use a valid coupon for shopping, receives a $5 discount for the first order, and a 1% discount off the sub-total for the next orders. If the entity places another order using a valid coupon, the entity will get 1% discount on the order and not $5. However, no customer can use their own coupon, which is assigned to them to distribute to other potential customer, to receive a discount on an order. If a customer tries to use their own coupon, the order is processed normally, without any value given.

Optionally, an entity can register an account with the company and place a first order without a coupon. Once the first order has been finalized, a confirmation is sent. A coupon can be attached to the order confirmation or placed in the entity's account for future purchases and referrals.

In another version, in order to prevent frauds, the amount of credit can be “pending” for predetermined period of time, such as, for example, 7 or 15, or 30 days. After the predetermined period of time has elapsed, the “pending” credit is transferred to “available credit” and is available for the next purchase. Alternatively, the available credit can be sent in form of a check at the end of the month.

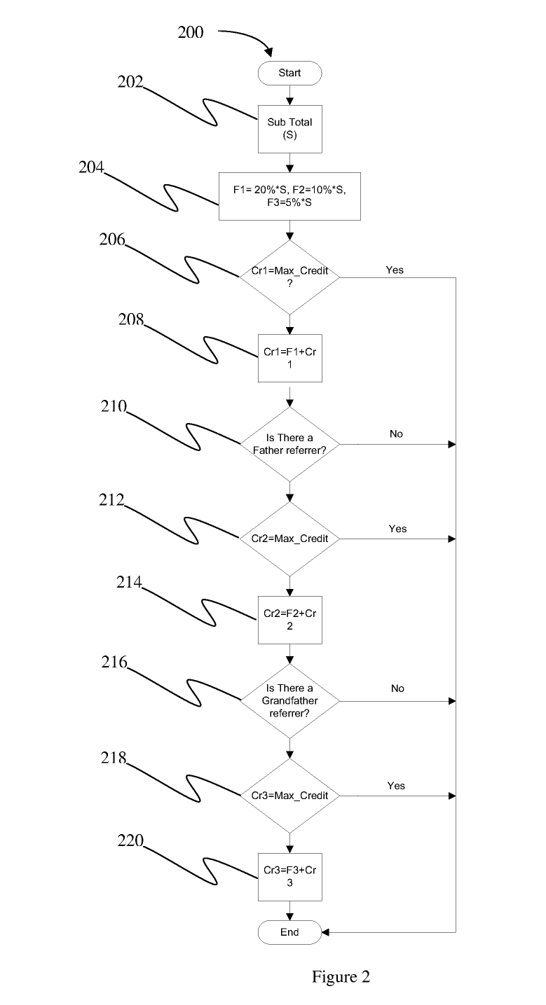

Referring now to FIG. 2, a sub-total (S) 202 is calculated for the customers order. Then, a percentage of the sub-total 204 is calculated for each referrer in the hierarchy, where each referrer is traced upwards by the link in the series that starts with the customer placing the order. For example, compensation calculation for the first previous referrer (F1) can be 20% of the sub-total, the compensation calculation for the second previous referrer (F2) can be 10% of the sub-total, and the compensation calculation for the third previous referrer (F3) can be 5% of the sub-total. Next, if the first previous referrer has reached the maximum amount of credit 206 that the company has set, the first previous referrer does not receive any value for the purchase. If the maximum credit 206 has not been reached, then the first previous referrer's account is credited 208 by F1. Optionally, there can be unlimited credit that never expires, or the credit can expire after a predetermined time limit set by the company. Then, if there is a second previous referrer 210, a determination is made if the second previous referrer has reached a set maximum amount of credit 212 established by the company. If the maximum credit 212 has been reached the second previous referrer does not receive any value for the purchase. However, if the maximum credit 212 has not been reached then the second previous referrer's account is credited by F2. Then, if there is a third previous referrer 216, a determination is made if the third previous referrer has reached the maximum amount of credit 218 that the company has set. If the maximum credit 218 has been reached the third previous referrer does not receive any value for the purchase. If the maximum credit 218 has not been reached then the third previous referrer's account is credited by F3.

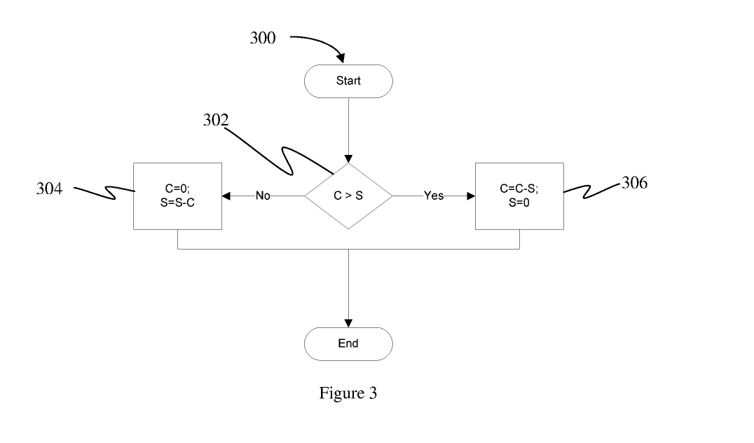

Referring now to FIG. 3, a determination whether the value received as a credit to the customer's account is greater than the sub-total of the purchase 302 is made. Then, if the credit is greater than the subtotal, the credit is reduced by the sub-total amount 306 and any remaining value is stored in memory for the next purchase by the entity. Next, if the credit is less than the sub-total, the credit is subtracted from the sub-total 304 and the sub-total is payable by the purchasing entity.

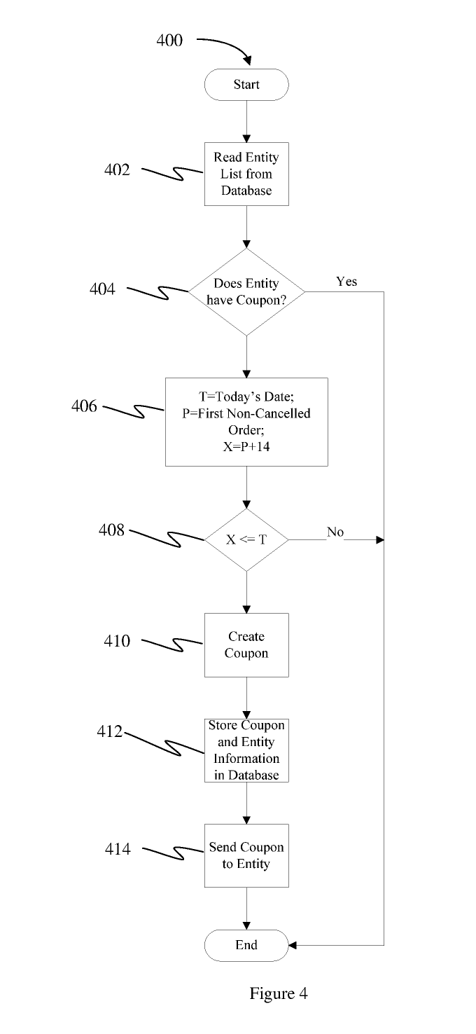

Referring now to FIG. 4 in the system, an entity list is read from the database 402. Then, a determination is made as to whether or not the entity has a coupon 404. If the entity has a coupon, then no new coupon is issued. Next, values are assigned to variables T, P and X 406, where T=today's date, P=first non cancelled order, and X=P+14. Then, a determination is made if X is less than or equal to T 408. If X is not less than or equal to T, then no coupon is issued. Next, a coupon is created 410 comprising an identifier. Then, the created coupon 410, the identifier and entity information is stored in the database 412. Next, the coupon is sent to the entity 414 for use in future purchases.

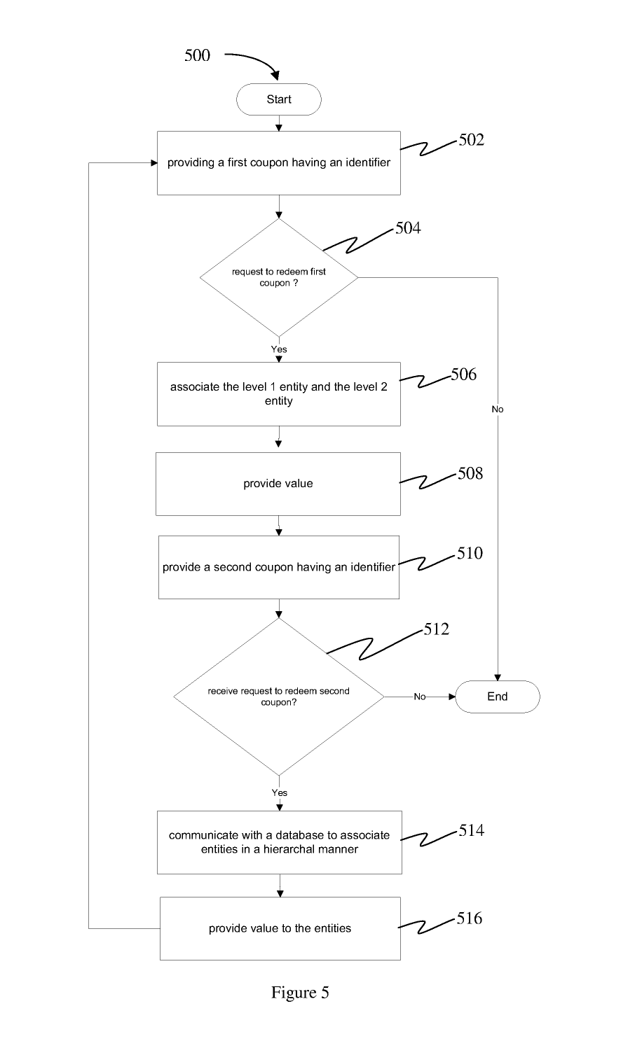

Referring now to FIG. 5, the system includes a method. According to a second version, the method comprises making a determination if an entity has entered a coupon 502. Then, the coupon is check as to whether or not it is available 504 to be used. Next, a coupon identifier 506 is entered by the purchasing entity. The coupon identifier can be any identifier that can be associated only with a single entity, such as, for example, an email address, a driver license number, or a social security number. Then, the coupon identifier is checked to determine if it is a valid coupon 508. Then, the database is checked to determine if this is the customer's first order 510. If this is the customer's first order, a discount 526 is given for the order. Next, a discount of the purchase 512 is given. Then, credits are calculated 514 for each entity in the hierarchy. Next, if the entity has no credit available for 516, the order is placed 520. Optionally, if there is credit available 516, then the order is placed 520 using the available credit 516. Then, if a coupon was used 502, the order is tracked 522 using the coupon identifier.

In one version, if a level 2 entity uses a coupon received from a level 1 entity to make a purchase, the level 1 entity receives a percentage of the level 2 entity's order total. Optionally, the value received can be a limited monetary amount such as, for example, a limit of up to $20 or 20% of the level 2 entity's order.

In another version, a credit assigned to the level 1 entity from the level 2 entity's order, is pending, and therefore not usable, until the end of the level 2 entity's chargeback period. The chargeback period refers to a specific time period, that the entity is able to cancel or return a placed order for any reason and claim a full refund. For example, this period can be 15 days or two weeks. At the end of the chargeback period the credit is active for the level 1 entity's use.

In another version, if the level 2 entity places an order using the level 1 entity's coupon, then the level 2 entity cancels the entire order during chargeback period, the credit amount granted to the level 1 entity is removed. In another version, if entity the level 2 entity places an order using the level 1 entity's coupon, then the level 2 entity cancels part of the order during chargeback period, the amount of credit granted to the level 1 entity is adjusted based on the new order total placed by the level 2 entity. For example, the level 2 entity places a $100.00 (USD) order using a coupon received from the level 1 entity. The level 1 entity will get $20 pending credit. Then the level 2 entity cancels part of the order and the order total becomes $80. The credit granted to the level 1 entity is adjusted from $20 to $16.

In another example, if entity the level 2 entity places order using he level 1 entity's coupon, and a level 3 entity places order using the level 2 entity's coupon, the level 2 entity will get %20 of the level 3 entity's order total (up to $20) and The level 1 entity will get %10 of the level 3 entity's order total (up to $10) of pending credit.

In yet another example, if the level 2 entity places order using the level 1 entity's coupon, and the level 3 entity places order using the level 2 entity's coupon, and a the level 4 entity places order using the level 3 entity's coupon, the level 3 entity will get %20 of the level 4 entity's order total (up to $20), and the level 2 entity will get %10 of the level 4 entity's order total (up to $10), and The level 1 entity will get %5 of the level 4 entity's order total (up to $5) of pending credit.

Optionally, the level of participation can be limited. In a preferred version, the level of participation can be limited to 4 levels. For example, if a level 5 entity uses the level 4 entity's coupon to place order, the level 4 entity receives 20% of the level 5 entity's order, the level 3 entity will get 10% of the level 5 entity's order, and the level 2 entity receives 5% of the level 5 entity's order, but the level 1 entity does not receive any value from the level 5 entity's order. In a particularly preferred version, each entity can use a coupon to place order only one time.

Although the present invention has been discussed in considerable detail with reference to certain preferred versions, other versions are possible. The steps disclosed for the present methods are not intended to be limiting nor are they intended to indicate that each step depicted is essential to the method, but instead are exemplary steps only. Therefore, the scope of the appended claims should not be limited to the description of preferred versions contained in this disclosure.

What is claimed is:

1. A method for attracting entities comprising the steps of:
a) providing a first coupon to a level lentity, the first coupon having an identifier associated only with the level 1 entity;
b) receiving a request to redeem the first coupon from a level 2 entity, wherein the request identifies the identifier of the first coupon;
c) communicating with a database upon receiving the request from the level 2 entity for associating the level 1 entity and the level 2 entity;
d) providing a value to the level 1 entity for at least one purchase by the level 2 entity;
e) providing the level 2 entity with a second coupon having an identifier associated only with the level 2 entity;
receiving a request to redeem the second coupon from a level 3 entity, wherein the request identifies the identifier of the second coupon;
g) communicating with a database upon receiving the request from the level 3 entity for associating the level 2 entity and the level 3 entity in a hierarchal manner; and
h) providing a value to the level land level 2 entities for at least one purchase by the level 3 entity.

2. The method of claim 1, comprising the additional step of providing a value to the level 2 entity for redeeming the first coupon and the value is selected from the group consisting of a cash value, an account credit value, a percentage off a purchase value, and combinations thereof.

3. The method of claim 2, where the value provided to the level 1 entity and the level 2 entity is not more than a predetermined amount.

4. The method of claim 2, where the value provided to the referring entity and each previous referring entity automatically expires after a predetermined time limit.

5. The method of claim 2, where the value provided to the level 1 and the level 2 entity is less than the value provided to the level 3 entity.

6. The method of claim 1, wherein the step of providing a first coupon to the level 1 entity comprises providing multiple coupons to the level 1 entity, each coupon provided to the level 1 entity having an identifier only associated with the level 1 entity.

7. The method of claim 1, further comprising the step of tracking orders for the level 2 entity, the 3 entity, or both the level 2 and the level 3 entity.

8. The method of claim 7, wherein the value provided to the level 1 entity is adjusted for cancelled orders by the level 2 entity.

9. The method of claim 7, wherein the value provided to the level 1 entity is adjusted by the percentage of orders returned by the level 2 entity.

10. The method of claim 7, wherein the value provided to the level 1 entity and the level 2 entity, is adjusted by the amount of the orders cancelled by the level 3 entity.

11. The method of claim 7, wherein the value provided to the level 1 entity and the level 2 entity are adjusted by the percentage of the orders returned by the level 3 entity.

12. A machine-readable medium having one or more instructions for attracting customers, which when executed by a processor causes the processor to:
a) provide a first coupon to a level lentity, the first coupon having an identifier associated only with the level 1 entity;
b) receive a request to redeem the first coupon from a level 2 entity, wherein the request comprises the identifier of the first coupon;
c) communicate with a database upon receiving the request from the level 2 entity for associating the level 1 entity and the level 2 entity;
d) provide a value to the level 1 entity for referring the level 2 entity;
e) provide the level 2 entity with a second coupon having an identifier associated only with the level 2 entity;
receive a request to redeem the second coupon from a level 3 entity, wherein the request comprises the identifier of the second coupon;
g) communicate with a database upon receiving the request from the level 3 entity for associating the level 2 entity and the level 3 entity in a hierarchal manner; and
h) provide a value to the level land level 2 entities for the level 2 entity referring the level 3 entity.
